(19) United States
(12) Patent Application Publication
(10) Pub. No.: US 2008/0100720 A1
(43) Pub. Date: May 1, 2008

(54) Cutout Effect For Digital Photographs

(76) Inventors: Kevin M. Brokish, Ft. Collins, CO (US); Andrew C. Goris, Loveland, CO (US); Robert P. Cazier, Ft. Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/554,538

(22) Filed: Oct. 30, 2006

(51) Int. Cl. H04N 5/228

(52) U.S. Cl. 348/222.1

(57) ABSTRACT

Systems and methods are disclosed for applying cutout effects to digital images. An exemplary method of applying a photo effect to either a subject or a background in a digital image on a camera may comprise subtracting a first image of both the background and the subject from a second image of only the background to generate a mask. The method may also comprise applying the photo effect to all of the first image. The method may also comprise restoring pixels corresponding to only the background or only the subject based on the mask to an original state so that the photo effect is applied to only the subject or only the background in a final image.

### BACKGROUND

Conventional film and more recently, digital cameras, are widely commercially available, ranging both in price and in operation from sophisticated single lens reflex (SLR) cameras used by professional photographers to inexpensive “point-and-shoot” cameras that nearly anyone can use with relative ease. Digital cameras are available with user interfaces that enable a user to select various camera features (e.g., ISO speed and red-eye removal).

Little is commercially available for allowing the user to create images on their camera from their own photographs that highlight either the subject or the background of the scene where the subject is being photographed. Software packages are available that allow users to edit their photographs. For example, the user may choose to “cut” a person out of a photograph of the person standing in a kitchen and “paste” the person into another photograph of a forest scene. Other algorithms are available for generating composite images where the subject from one image is overlaid onto another image. However, these images may appear to have been altered. For example, it may by readily apparent that the person is not really standing in the forest.

### BRIEF DESCRIPTION OF THE DRAWINGS

FIG. 1 is a block diagram of an exemplary camera system which may implement a cutout effect for digital photographs.

FIG. 2 are simplified illustrations of digital images showing an exemplary embodiment for generating a mask.

FIG. 3 are simplified illustrations of a mask showing an exemplary implementation for applying connected component labeling to remove noise.

FIG. 4 are simplified illustrations of digital images showing an exemplary embodiment for producing a cutout effect using a mask.

FIG. 5 is a flowchart illustrating exemplary operations to implement a cutout effect for digital photographs.

### DETAILED DESCRIPTION

Systems and methods are disclosed for highlighting a subject in a digital photograph (referred to herein as a “cutout effect”). In an exemplary embodiment, the camera user takes two digital images of the same scene, e.g., the first one having a subject and the second one without the subject. The first image is then “subtracted” from the second image to generate a mask. Optionally, various algorithms (e.g., collective component labeling, median filter, etc.) may be applied for “cleaning” the mask (e.g., removing noise or other imperfections). A photo effect can then be applied to either the background or the subject using the mask and the second image. For example, if the user wants the image to have a color subject on a black/white background, the first image may be converted to black/white, the pixels for the subject are identified using the mask, and then only those pixels for the subject are converted to color. Alternatively, the pixels for the subject may be identified and/or the pixels for the background may be identified using the mask, and then only those pixels that are to be changed are converted to apply the effect (e.g., to apply various types of coloring such as real, cartoon, watercolor, psychedelic, black-and-white, grayscale, etc.).

Exemplary systems may be implemented as an easy-to-use user interface displayed on the digital camera and navigated by the user with conventional camera controls (e.g., arrow buttons and zoom levers already provided on the camera). The user needs little, if any, knowledge about photo-editing, and does not need special software for their PC to create a cutout effect for their digital images.

### Exemplary Systems

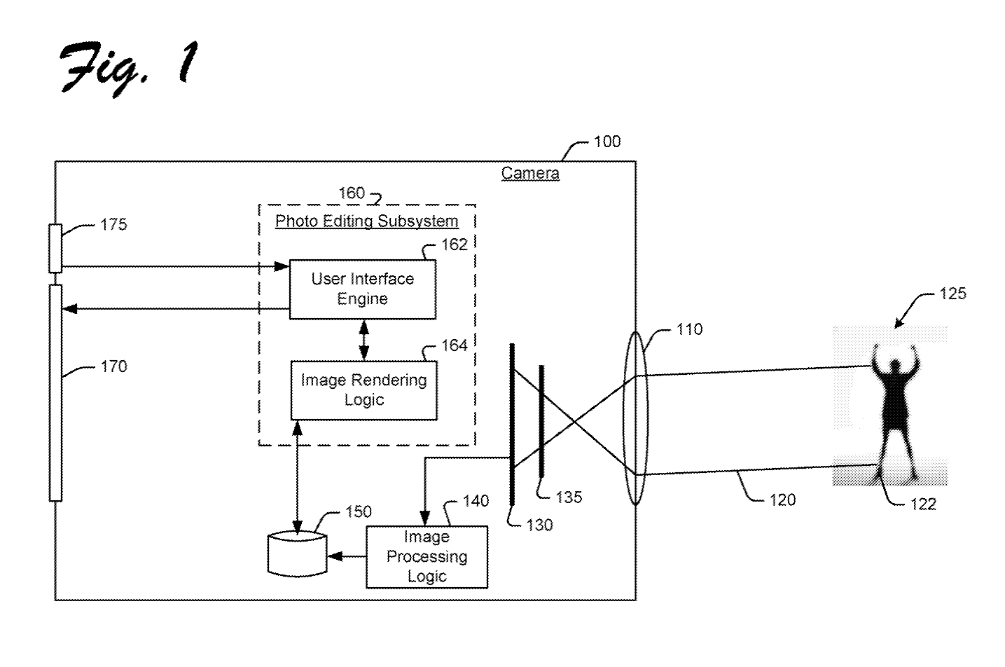

FIG. 1 is a block diagram of an exemplary camera system which may implement a cutout effect for digital photographs. The exemplary camera system may be a digital camera 100 including a lens 110 positioned to focus light 120 reflected from one or more objects 122 in a scene 125 onto an image capture device or image sensor 130 when a shutter 135 is open (e.g., for image exposure). Exemplary lens 110 may be any suitable lens which focuses light 120 reflected from the scene 125 onto image sensor 130.

Exemplary image sensor 130 may be implemented as a plurality of photosensitive cells, each of which builds-up or accumulates an electrical charge in response to exposure to light. The accumulated electrical charge for any given pixel is proportional to the intensity and duration of the light exposure. Exemplary image sensor 130 may include, but is not limited to, a charge-coupled device (CCD), or a complementary metal oxide semiconductor (CMOS) sensor.

Camera system 100 may also include image processing logic 140. In digital cameras, the image processing logic 140 receives electrical signals from the image sensor 130 representative of the light 120 captured by the image sensor 130 during exposure to generate a digital image of the scene 125. The digital image may be stored in the camera's memory 150 (e.g., a removable memory card).

Shutters, image sensors, memory, and image processing logic, such as those illustrated in FIG. 1, are well-understood in the camera and photography arts. These components may be readily provided for digital camera 100 by those having ordinary skill in the art after becoming familiar with the teachings herein, and therefore further description is not necessary.

Digital camera 100 may also include a photo-editing subsystem 160. In an exemplary embodiment, photo-editing subsystem 160 is implemented in program code (e.g., firmware and/or software) residing in memory on the digital camera 100 and executable by a processor in the digital camera 100, such as the memory and processor typically provided with commercially available digital cameras. The photo-editing subsystem 160 may include user interface engine 162 and image rendering logic 164 for producing digital photographs with a cutout effect.

The image rendering logic 164 may be operatively associated with the memory 150 for accessing digital images (e.g., reading the images stored in memory 150 by image processing logic 140 or writing the images generated by the image rendering logic 164). Image rendering logic 164 may include program code for applying a cutout effect to the digital images and stored on the camera 100, as will be explained in more detail below. The image rendering logic 164 may also be operatively associated with the user interface engine 162.

User interface engine 162 may be operatively associated with a display 170 and one or more camera controls 175 already provided on many commercially available digital cameras. Such an embodiment reduces manufacturing costs (e.g., by not having to provide additional hardware for implementing the photo-editing subsystem 160), and enhances usability by not overwhelming the user with additional camera buttons.

During operation, the user interface engine 162 displays a menu on the digital camera (e.g., on display 170). In an exemplary embodiment, the menu may be accessed by a user selecting the design gallery menu option. The menu may then be navigated by a user making selections from any of a variety menus options. For example, the user interface engine 162 may receive input (e.g., via one or more of the camera controls 175) identifying user selection(s) from the menu for generating an image having the desired cutout effect. The image rendering logic 164 may then be implemented to apply a cutout effect to a digital image stored in the digital camera 100 (e.g., in memory 150) based on user selection(s) from the menu.

A preview image may be displayed on display 170 so that the user can see the cutout effect. Optionally, instructive text may also be displayed on display 170 for modifying, or accepting/rejecting the cutout effect. The instructive text may be displayed until the user operates a camera control 175 (e.g., presses a button on the digital camera 100). After the user operates a camera control 175, the test may be removed so that the user can better see the preview image and cutout effect on display 170.

Also optionally, the user may operate camera controls 175 (e.g., as indicated by the instructive text) to modify the cutout effect. For example, the user may press the left/right arrow buttons on the digital camera 100 to change between the photo effect being applied to the subject or to the background.

In an exemplary embodiment, a copy of the original digital photograph is used for adding a cutout effect to an image stored on the digital camera 100. For example, the new image may be viewed by the user on display 170 directly after the original image so that the user can readily see both the original image and the modified image.

Before continuing, it is noted that the digital camera 100 shown and described above with reference to FIG. 1 is merely exemplary of a camera which may implement a cutout effect for digital photographs. The systems and methods described herein, however, are not intended to be limited only to use with the digital camera 100. Other embodiments of cameras and/or systems which may implement a cutout effect for digital photographs are also contemplated.

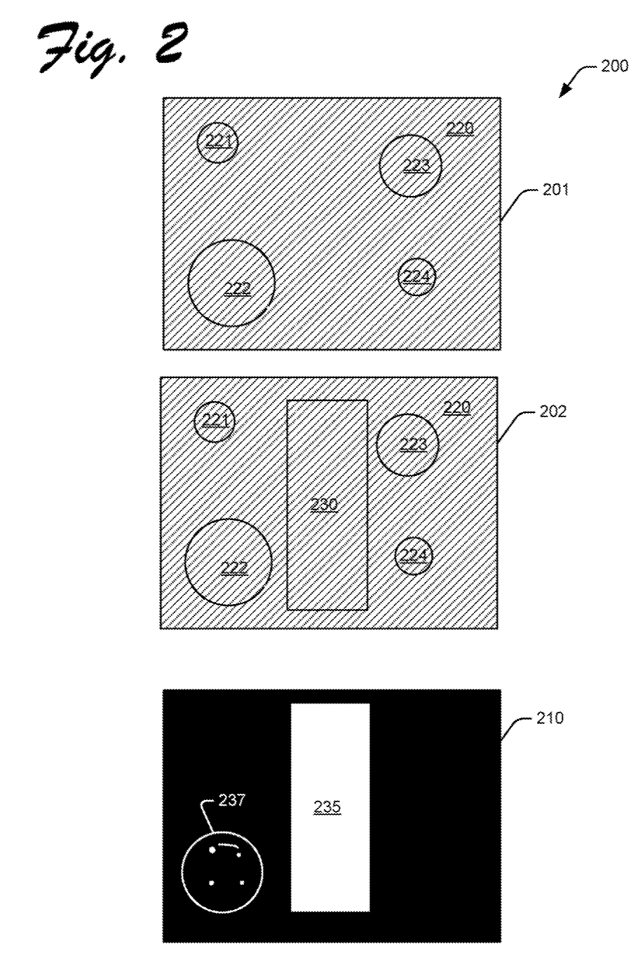

FIG. 2 are simplified illustrations 100 of digital images showing an exemplary embodiment for generating a mask 210. For purposes of this example, cross-hatching extending from the top-right hand corner of the image toward the bottom-left hand corner of the image indicates color.

In an exemplary embodiment, the camera user takes a first digital photograph 201 of a background scene 220 having background objects 221-224. The camera user then takes a second digital photograph 202 of the same scene 220 with a subject 230. The second digital photograph 202 is “subtracted” from the first digital photograph on a pixel-by-pixel (or group of pixel to group of pixel) basis to generate the mask 210.

Various embodiments are contemplated for maintaining a constant background 220 between the images 201 and 202. For example, the camera user may take the digital photographs 201 and 202 using a tripod or other stabilizing device for the camera. In another example, the images 201 and 202 may be registered with one another by aligning one or more objects in the background to accommodate camera movement (e.g., where a tripod is not used). In still another example, image stabilizing systems may be implemented in the camera to accommodate movement of the camera. Image stabilizing systems are well known in the camera arts and may be readily implemented by those having ordinary skill in the art after becoming familiar with the teachings herein. Image recognition techniques may also be employed to identify the subject and accommodate changes in the scene itself (e.g., changing light, natural movement of grass, tree leaves, or other scenery, etc.).

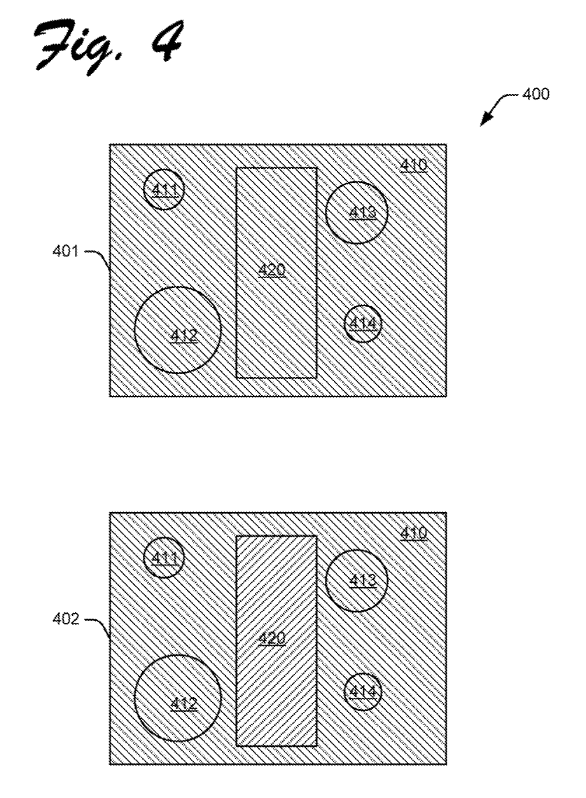

In any event, the mask 210 may be coded, e.g., as a white on black image (or black on white, or other suitable coding scheme), wherein the pixels corresponding to the subject are assigned a white value and the pixels corresponding to the background are assigned a black value. The mask 210 may then be used to produce an image with the cutout effect, as explained in more detail below with reference to FIG. 4.

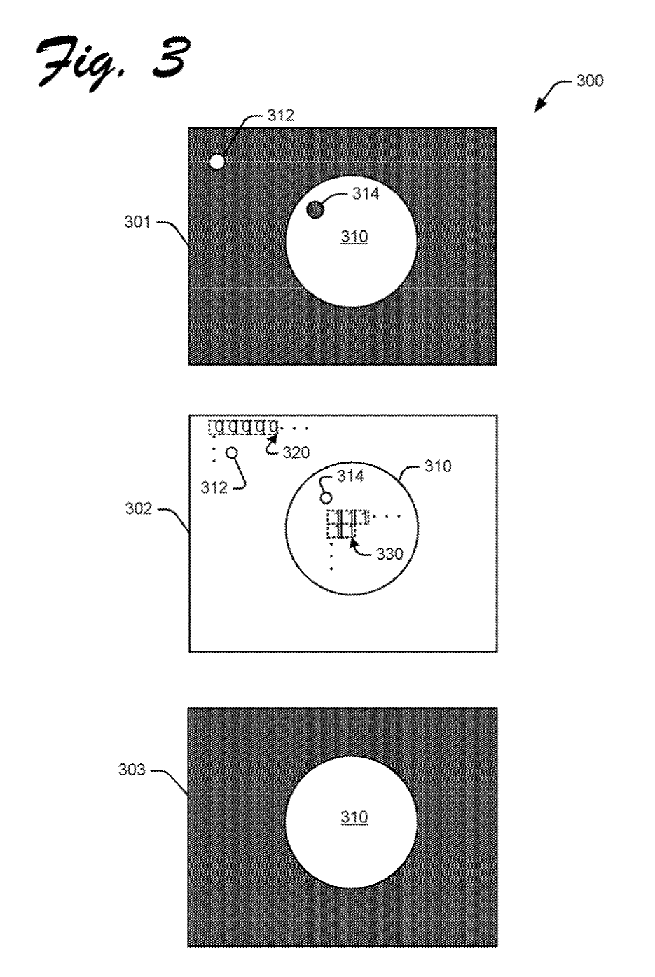

Before continuing, however, it is observed that the mask 210 includes both a subject area 235 in addition to other lines or “noise” (generally observed in area 237). In an exemplary embodiment, a medial filter may be implemented to reduce noise in the mask 210. In another exemplary embodiment, connected component labeling techniques may be applied to remove lines which do not satisfy a count threshold to reduce noise in the mask 210. Although these and other embodiments for reducing noise appearing in digital images are well known in the camera arts, for purposes of illustration, an exemplary embodiment for applying connected component labeling to a mask is described below with reference to FIG. 3.

FIG. 3 are simplified illustrations 300 of a mask (e.g., the mask 210 in FIG. 2) showing an exemplary implementation for applying connected component labeling to remove noise. For purposes of this example, image 301 includes a subject 310 and noise elements 312, 314. Image 302 illustrates analysis of the image 301 using connected component labeling. An image 303 shows the mask after noise elements 312, 314 have been removed by application of connected component labeling.

During connected component labeling, the image is analyzed by scanning the pixels (illustrated by the pixels 320 in image 302), or groups of pixels. The pixels may be scanned right to left and top to bottom on a first pass, then left to right and bottom to top on a second pass, or any other suitable approach for scanning the pixels.

In an exemplary embodiment, pixels are either assigned a “0” (e.g., pixels 320) or a “1” (e.g., pixels 330) based on a threshold value. Only the groups or clusters of pixels which satisfy this threshold value are assigned a “1”. Groups or clusters of pixels which do not satisfy this threshold value are assigned a “0”. In this example, the pixels corresponding to the noise element 312 does not satisfy the threshold value, and therefore these pixels are assigned “0”, the same value assigned the background pixels. All of the pixels comprising the subject 310 satisfy the threshold value and therefore are all assigned “1”. Accordingly, the noise elements 312, 314 are eliminated when the mask 303 is rendered.

Various embodiments for establishing a threshold value are contemplated. Typically, however, the threshold value is selected to remove undesirable “noise” from the mask without slowing camera operations.

FIG. 4 are simplified illustrations 400 of digital images showing an exemplary embodiment for producing a cutout effect using a mask (e.g., the mask 210 in FIG. 2 or the “clean version” of the mask 303 in FIG. 3). Although any suitable the photo effect (e.g., sepia, grayscale, or black-and-white “coloring”) may be used in either the background 410 or on the subject 420 to highlight the subject against the background, a grayscale photo effect was selected for this example.

The photo effect may be applied by filtering the original digital photograph containing the subject (e.g., image 202 in FIG. 2). Accordingly, all of the pixels (including the subject 420 and background objects 411-414 in the scene 410) are converted to the photo effect to produce, in this example, a grayscale image 401. For purposes of this example, cross-hatching extending from the top-left hand corner of the image toward the bottom-right hand corner of the image indicates grayscale.

The pixels corresponding to the subject 420 may then be identified in the image 401 using the mask. Only those pixels corresponding to the subject 420 are converted back to their original format (e.g., color) to produce image 402 having a color subject 420 (indicated by cross-hatching extending from the top-right hand corner toward the bottom-left hand corner) on a grayscale background 410 (indicated by cross-hatching extending from the top-left hand corner toward the bottom-right hand corner). Alternatively, the pixels for the subject may be identified and/or the pixels for the background may be identified using the mask, and then only those pixels that are to be changed are converted to apply the effect.

It is noted that the example described above with reference to FIG. 4 is not intended to be limiting. Other embodiments are also contemplated for producing a digital photograph with a cutout effect to highlight the subject against the background. For example, all of the pixels in the original digital photograph may be left in their original format (e.g., as color pixels), and the photo effect may only be applied to pixels corresponding to the background identified using the mask. In yet another example, a first photo effect may be applied to all of the pixels and then a second photo effect may be applied to either the background or the subject. Still other embodiments are also contemplated.

### Exemplary Operations

Exemplary operations which may be used to implement a cutout effect for digital photographs may be embodied as logic instructions on one or more computer-readable medium. When executed on a processor (e.g., in the camera), the logic instructions implement the described operations. In an exemplary embodiment, the components and connections depicted in the figures may be implemented.

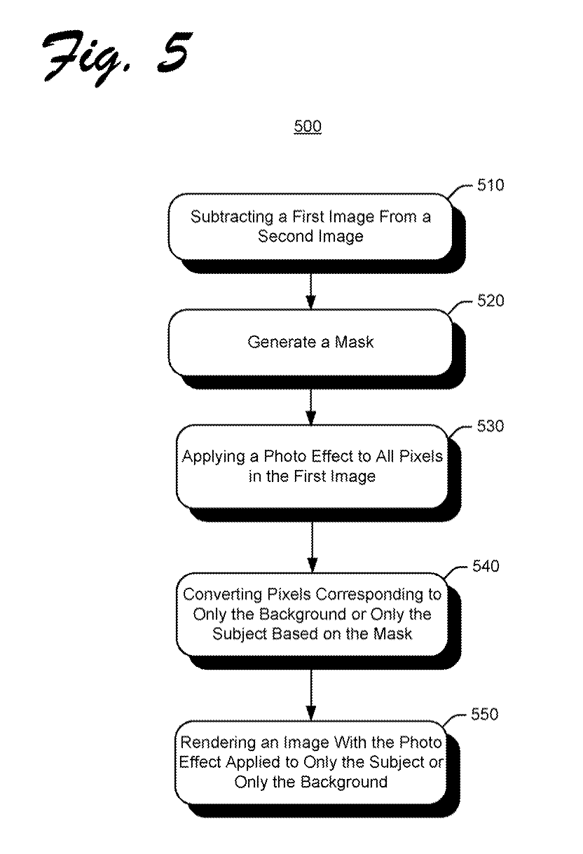

FIG. 5 is a flowchart illustrating exemplary operations 500 to implement a cutout effect for digital photographs. In operation 510, a first image is subtracted from a second image. For example, a digital photograph having a subject may be subtracted from another digital photograph of substantially the same scene but without the subject.

In operation 520, the subtraction operation is used to generate a mask. Optionally, generating a mask may also include the operations of cleaning the mask to remove noise. For example, connected component labeling or a median filter may be applied to remove noise from the mask.

In operation 530, a photo effect is applied to all of the pixels in the first image. For example, the photo effect may be the application of “grayscale” tones. In operation 540, pixels corresponding to only the background or only the subject are converted to their original format based on the mask. For example, pixels corresponding to the subject may be converted to color if it is desired to highlight the subject in color on a grayscale background. Alternatively, pixels corresponding to the background may be converted to color if it is desired to highlight the subject in grayscale on a color background. In operation 550, an image is rendered with the photo effect applied to only the subject or only the background.

Other operations, not shown, are also contemplated and will be readily apparent to those having ordinary skill in the art after becoming familiar with the teachings herein. For example, a separate copy of the digital image may be stored in memory before applying the cutout effect to the selected digital image. Accordingly, the user can revert back to the original digital image if the user decides that they do not like the cutout effect they have chosen without having to undo all of the changes.

It is noted that the exemplary embodiments shown and described are provided for purposes of illustration and are not intended to be limiting. Still other embodiments for implementing a cutout effect for digital photographs are also contemplated.

1. A digital camera systems comprising:
computer-readable storage for storing a first image and a second image in the digital camera;
image rendering logic executing in the digital camera to generate a cutout effect for the at least one digital image, the image rendering logic:
subtracting pixel values for a first image from pixel values for a second image to generate a mask separating a subject from a background;
applying a photo effect to either the background or the subject in the first image using the mask so that the photo effect is applied to only the subject or only the background in a rendered image.

2. The digital camera system of claim 1, wherein the image rendering logic registers the background in the first and second images before subtracting pixel values to generate the mask.

3. The digital camera system of claim 2, wherein registering the background in the first and second images accommodates movement of the digital camera in the time between when the first and second images are captured.

4. The digital camera system of claim 2, wherein registering the background in the first and second images accommodates changes in the scene being photographed in the time between when the first and second images are captured.

5. The digital camera system of claim 1, wherein the image rendering logic filters the mask to remove noise.

6. The digital camera system of claim 5, wherein the image rendering logic applies connected component labeling to the mask to remove noise from the mask before converting pixel values.

7. The digital camera system of claim 5, wherein the image rendering logic uses subject-recognition to identify the subject and then remove noise from the mask before converting pixel values.

8. A method of applying a photo effect to either a subject or a background in a digital image on a camera comprising:
subtracting a first image of both the background and the subject from a second image of only the background to generate a mask;
applying the photo effect to all of the first image; and
restoring pixels corresponding to only the background or only the subject based on the mask to an original state so that the photo effect is applied to only the subject or only the background in a rendered image.

9. The method of claim 8, further comprising switching the photo effect between being applied to the background and being applied to the subject for display to the user.

10. The method of claim 8, further comprising registering the first and second images if the background in the first image does not match the background in the second image.

11. The method of claim 8, further comprising making a copy of the digital image stored in the camera to preserve the digital image as an original.

12. The method of claim 8, further comprising displaying a preview image showing the subject highlighted on the background for the user to accept or reject before saving as a digital image.

13. The method of claim 8, further comprising filtering the mask to remove noise.

14. The method of claim 13, wherein filtering is by connected component labeling.

15. A computer program product encoding computer programs for producing a cutout effect for a digital photograph, the computer process comprising executable program code executing on a digital camera for:
subtracting a first image from a second image to generate a mask separating a background from a subject being photographed;
applying a photo effect to all of the first image having both the background and the subject;
converting pixels corresponding to only the background or only the subject based on the mask to an original state so that the photo effect is applied to only the subject or only the background; and
rendering the digital photograph highlighting the subject.

16. The computer program product of claim 15, further comprising executable program code for registering the background in the first and second images before subtracting pixel values to generate the mask.

17. The computer program product of claim 15, further comprising executable program code for registering the background in the first and second images to accommodate movement of the digital camera during image capture operations.

18. The computer program product of claim 15, further comprising executable program code for registering the background in the first and second images to accommodate changes in the scene between the first and second images.

19. The computer program product of claim 15, further comprising executable program code for filtering the mask to remove noise.

20. The computer program product of claim 15, further comprising executable program code for applying connected component labeling to the mask to remove noise from the mask.

21. The computer program product of claim 15, further comprising executable program code for recognizing a subject area for the subject and then removing noise from the mask based on the identified subject area.
